(19) United States
(12) Patent Application Publication
(10) Pub. No.: US 2019/0067652 A1
(43) Pub. Date: Feb. 28, 2019

(54) Electrically Isolated Battery Can Assembly

(71) Applicant: Apple Inc., Cupertino, CA (US)

(72) Inventors: Brian K. Shiu, Sunnyvale, CA (US); Christopher R. Pasma, Mountain View, CA (US)

(21) Appl. No.: 15/955,095

(22) Filed: Apr. 17, 2018

Related U.S. Application Data
(60) Provisional application No. 62/549,290, filed on Aug. 23, 2017.

(51) Int. Cl. H01M 2/08; H01M 2/02; H01M 2/04

(52) U.S. Cl. CPC H01M 2/08; H01M 2/0486; H01M 2/0285

(57) ABSTRACT

A battery can assembly may include the use of insulating adhesive between the can and cover. Because the cover and can are electrically isolated from each other, the respective battery terminals may be directly coupled thereto, eliminating a feed-through to connect electrodes to positive and negative terminals. Such an assembly can eliminate the need for an electrically insulated feed-through. Additionally, welding between the cover and can, which in some cases may be difficult due to shape, size, and or restricted access, may also be eliminated. This can allow for significant simplification of the battery assembly process.

### TECHNICAL FIELD

This disclosure relates generally to the field of electric batteries and, in particular, to assembly of batteries.

### BACKGROUND

In assembly of a battery, an anode (i.e., positive electrode) and a cathode (i.e., negative electrode) that are separated by one or more insulating sheet(s) and separator layer(s) may be rolled up or stacked in lamination to form a core. The core may then be enclosed in a can, e.g., a metallic cover made of stainless steel, aluminum, or another conductive material or alloy. The can may then be welded to a cover to form an casing enclosing the core. The can (and the cover) may be electrically connected to a first electrode, e.g., the cathode, to form a negative terminal, while a second electrode, e.g., the anode, may be brought out through the wall or lid of the can using an electric lead via a feed-through to form a positive terminal.

The above-described assembly might pose several constraints. First, the above-described assembly may have strict requirements on electrical insulation of the feed-through to ensure secure isolation between the negative and positive terminals. Second, it may require welding with high precision at difficult-to-access areas between the cover and can. In manufacturing, the constraints may limit production efficiency and cause challenges to quality control and reliability assurance.

### SUMMARY

This disclosure describes improved battery assemblies. Such an assembly may include the use of insulating adhesive between a battery's cover and can. Because the cover and can are electrically isolated from each other, the battery may eliminate a feed-through to connect electrodes to positive and negative terminals. For example, a cathode of the core may be connected to the can to produce a negative terminal, while an anode of the core may be connected to the cover to form a positive terminal (or vice versa). The disclosed assembly may eliminate the need of electrically insulated feed-through, as well as welding between the cover and can, thus simplifying the assembly process.

### BRIEF DESCRIPTION OF THE DRAWINGS

Various embodiments of the disclosed concepts are illustrated by way of example and not by way of limitation in the accompanying drawings in which like references indicate similar elements. It should be noted that references to “an”, “one” or “another” embodiment in this disclosure are not necessarily to the same or different embodiment, and they mean at least one. In order to be concise, a given figure may be used to illustrate the features of more than one embodiment, or more than one species of the disclosure, and not all elements in the figure may be required for a given embodiment or species. Additionally, features from multiple figures may be combined into some embodiments.

FIG. 1 illustrates an exemplary battery with welded assembly.

FIG. 2 illustrates a detail view of an exemplary battery with welded assembly.

FIG. 3 illustrates a top view of an exemplary battery with welded assembly.

FIG. 4 illustrates a bottom view of an exemplary battery with welded assembly.

FIG. 5 illustrates an exemplary battery with adhesive assembly.

FIG. 6 illustrates a detail view of an exemplary battery with adhesive assembly.

FIG. 7 illustrates a top view of an exemplary battery with adhesive assembly.

FIG. 8 illustrates a bottom view of an exemplary battery with adhesive assembly.

FIG. 9 illustrates an alternative battery with adhesive assembly.

### DETAILED DESCRIPTION

In the following description, for purposes of explanation, numerous specific details are set forth to provide a thorough understanding of the disclosed concepts. As part of this description, some of this disclosure's drawings represent structures and devices in block diagram form to avoid obscuring the disclosure. In the interest of clarity, not all features of an actual implementation are described in this disclosure. Moreover, the language used in this disclosure has been principally selected for readability and instructional purposes, and may not have been selected to delineate or circumscribe the disclosed subject matter, resort to the claims being necessary to determine such disclosed subject matter.

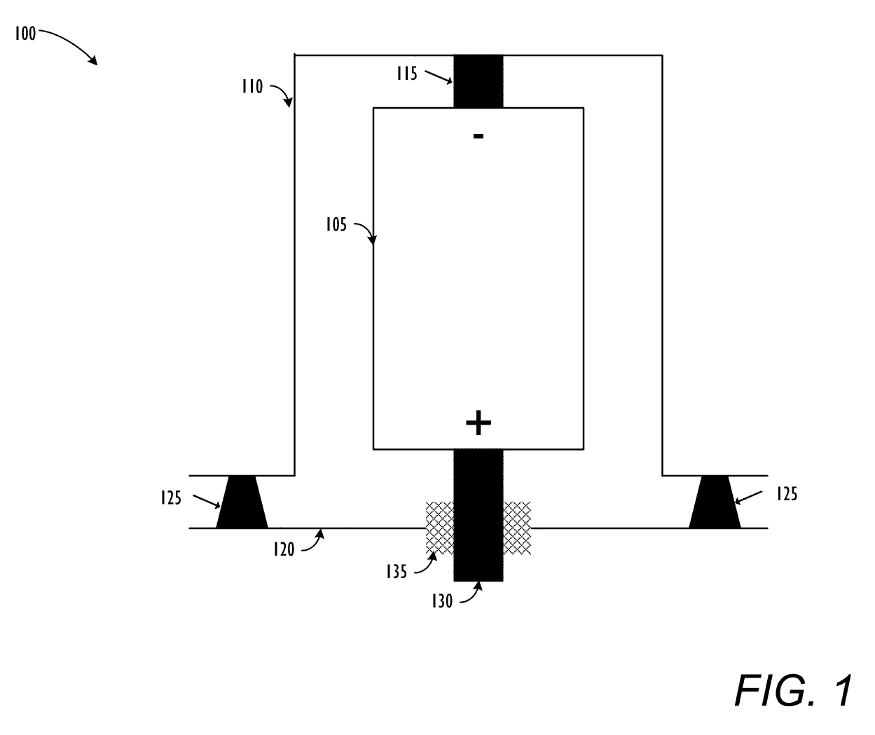

FIG. 1 illustrates battery 100 with welded can assembly. As shown in FIG. 1, battery 100 may include core 105 comprising a cathode and an anode. The core may be formed in a jelly roll configuration, in which broad electrode and separator sheets are rolled into a tighter shape for packaging, or a stacked configuration in which multiple layers of electrode and separator are stacked and electrically connected according to known battery construction techniques. For example, a stacked core may include a plurality of electrodes electrically connected to form a cathode, a further plurality of electrodes electrically connected to form an anode, with a plurality of separator and electrolyte layers interleaved between. A first electrode (e.g., cathode) of core 105 may be electrically connected to can 110 through electrical lead 115 using, for example, welding, pressure contact, conductive adhesive, etc. Battery 100 may also include cover 120, which may be welded to can 110 through welding connections 125 so as to form a casing enclosing core 105. Thus, the cathode of core 105, can 110, and cover 120, all together, may form a negative terminal of battery 100. A second electrode (e.g., anode) of core 105 may be brought out using electrical lead 130 to form a positive terminal of battery 100. To ensure electrical isolation between the negative and positive terminals, battery 100 may employ feed-through 135 to develop electrical insulation between lead 130 (and anode of core 105) and cover 120 (and cathode of core 105). Feed-through 135 may be implemented using insulating materials with further sealing properties to provide any required mechanical integrity. Although the illustrated embodiment has the anode fed through the cover 120, it will be appreciated that either the anode or cathode may use a feed through connection, and that the feed through connection may pass through can 110 rather than cover 120.

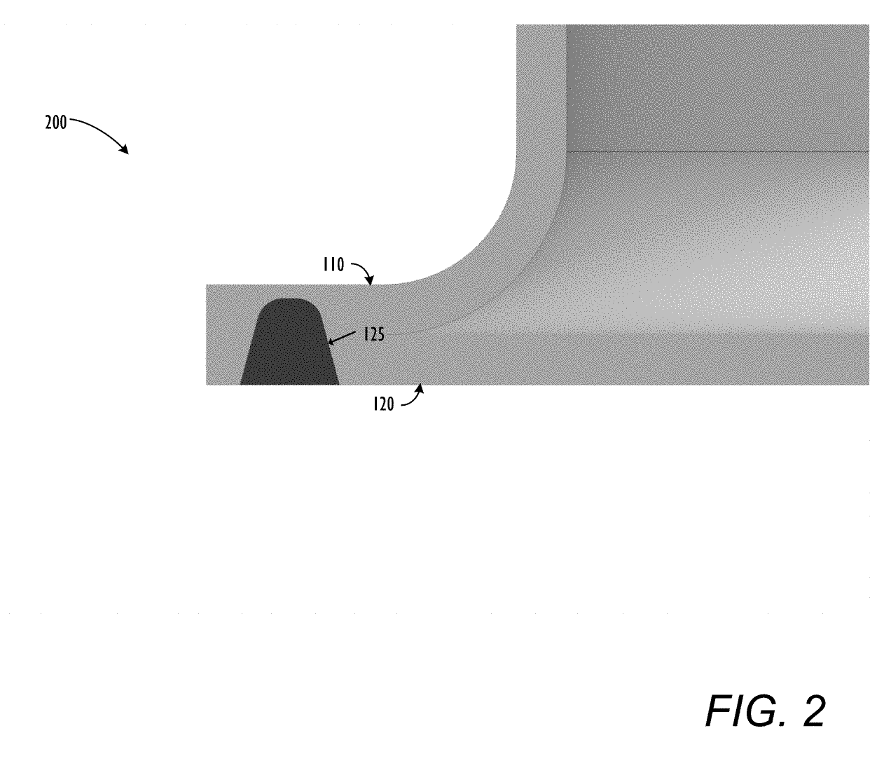

FIG. 2 further illustrates detail view 200 of the welding assembly of battery 100. To facilitate understanding, identical components in FIGS. 100 and 200 may use the same references. As shown in detail view 200, welding connection 125 may be applied between can 110, e.g., around a flange-shaped expansion, and cover 120. Welding connection 125 underneath can 110 on top of cover 120 may necessitate difficult access, especially for batteries in small packages and/or irregular shapes.

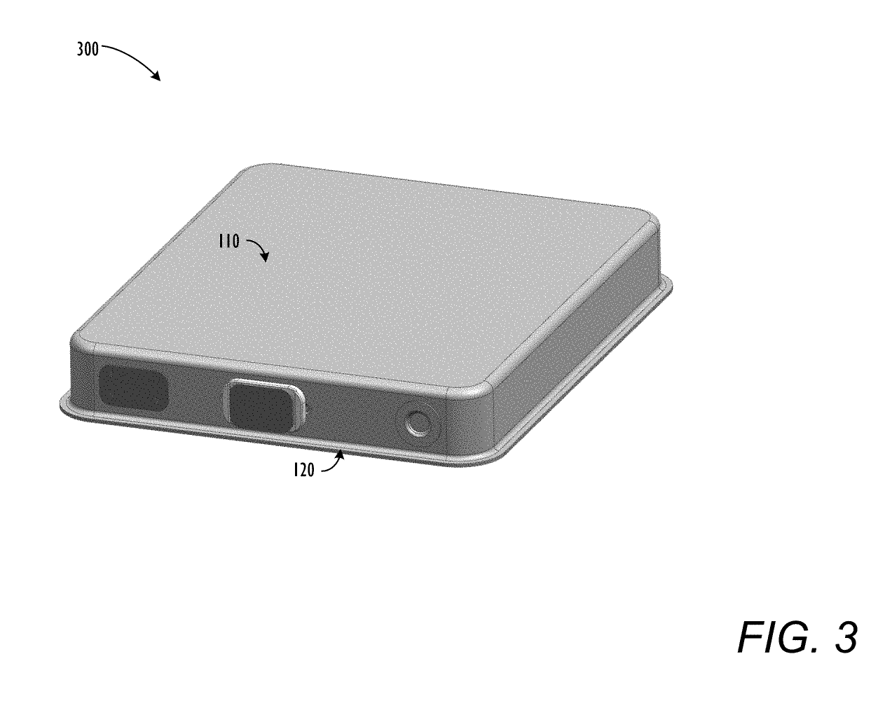

FIG. 3 illustrates top view 300 of battery 100 with welding assembly. As shown in top view 300, battery 100 may resemble a rectangular button cell, for purposes of illustration only, with can 110 and cover 120. As an alternative, battery 100 may employ a variety of exterior and/or interior dimensions and structures, for example, as a cylindrical cell, a button cell, a brick-shaped cell, and/or in an irregular shape.

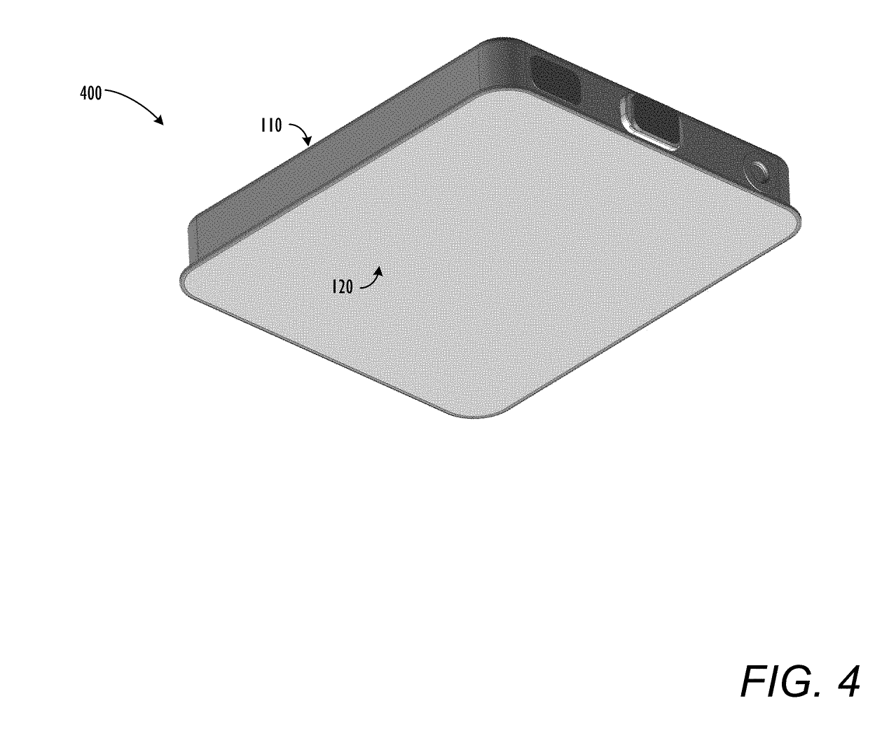

FIG. 4 illustrates bottom view 400 of battery 100 with welding assembly. As shown herein, can 110 and cover 120 may provide respective negative and positive terminals for battery 100, for example.

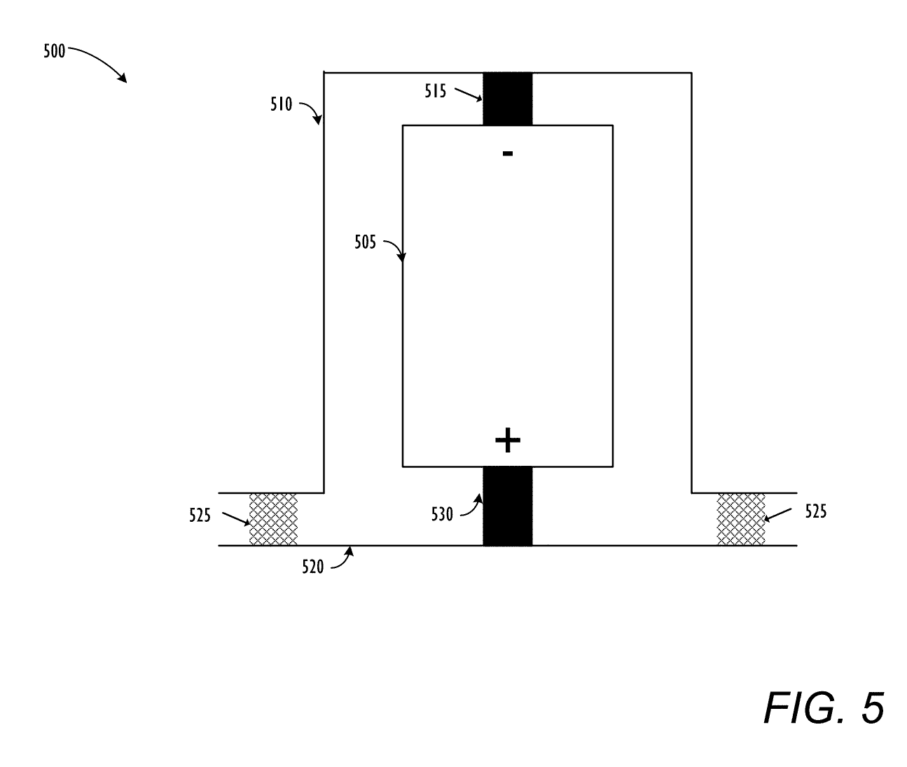

To address the above-mentioned constraints of the welding assembly of battery 100, FIG. 5 illustrates battery 500 assembled using an insulating adhesive rather than a weld to join can 510 to cover 520. As shown in FIG. 5, battery 500 may include core 505 comprising a cathode and an anode. As noted above, the core may be constructed in a rolled or stacked configuration. A first electrode (e.g., cathode) of core 505 may be electrically connected to can 510 through electrical lead 515 using, for example, welding, pressure contact, conductive adhesive, etc. Battery 500 may also include cover 520, which may be mechanically coupled to can 510 using insulating adhesive 525 so as to form a casing enclosing core 505. Further, a second electrode (e.g., anode) of core 505 may be electrically connected to cover 520 through lead 530. Thus, the cathode of core 505 and can 510 may form a negative terminal for battery 500. Conversely, the anode of core 505 and cover 520 may produce a positive terminal for battery 500. It will be appreciated that the electrical connections to the anode and cathode may be reversed so that the cathode is connected to cover 520 and the anode is connected to can 510.

Because battery 500 uses insulating adhesive 525 rather than welding to mechanically couple can 510 and cover 520, battery 500 may eliminate the need for a feed-through between lead 530 and cover 520. Adhesive 525 may use any of a variety of known adhesive materials with electrically insulating properties, such as acrylic adhesives, polypropylene substrates laced with adhesives (e.g., a tape), polyamides, Mylar, etc. For example, adhesive 525 may be implemented by a double-sided insulating tape, such as those comprising a polymer substrate in the middle with a suitable adhesive on both sides. Adhesive 525 may include an SBR material (styrene butadiene rubber) or may belong to the PVDF (polyvinylidene fluoride) or PTFE (polytetrafluoroethylene) families, for example. It will be appreciated that the particular adhesive and/or substrate material used in a particular embodiment should be selected to be compatible with the associated battery chemistry.

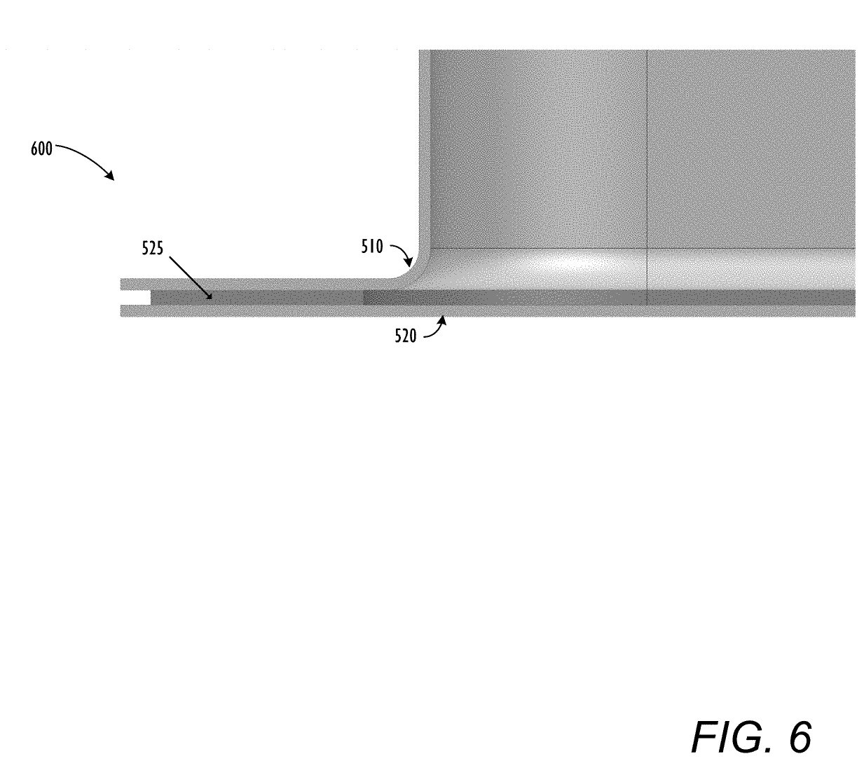

FIG. 6 further illustrates detail view 600 of a battery 500 assembled using an adhesive as described above. To facilitate understanding, identical components in FIGS. 500 and 600 may use the same references. As shown in detail view 600, adhesive 525 may be applied between can 510, e.g., around a flange-shaped expansion, and cover 120. In comparison with detail view 200 in FIG. 2, it can be seen that the difficult to access welding connections may be eliminated.

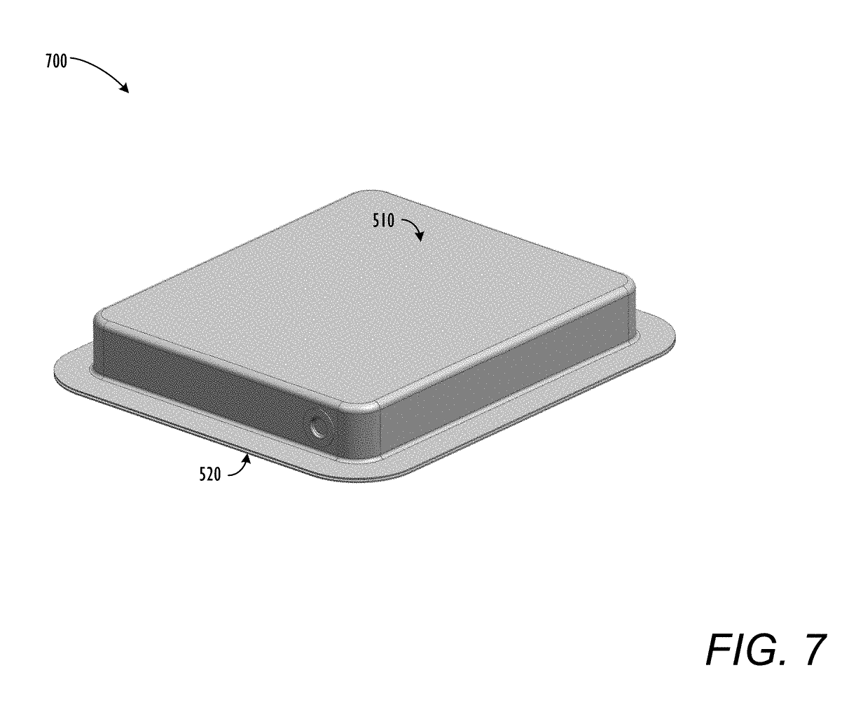

FIG. 7 illustrates top view 700 of battery 500 with adhesive assembly. As shown in top view 700, battery 500 may resemble a rectangular button cell, for purposes of illustration only, with can 110 and cover 120. As an alternative, battery 100 may employ a variety of exterior and/or interior dimensions and structures, for example, as a cylindrical cell, a button cell, a brick-shaped cell, and/or in an irregular shape.

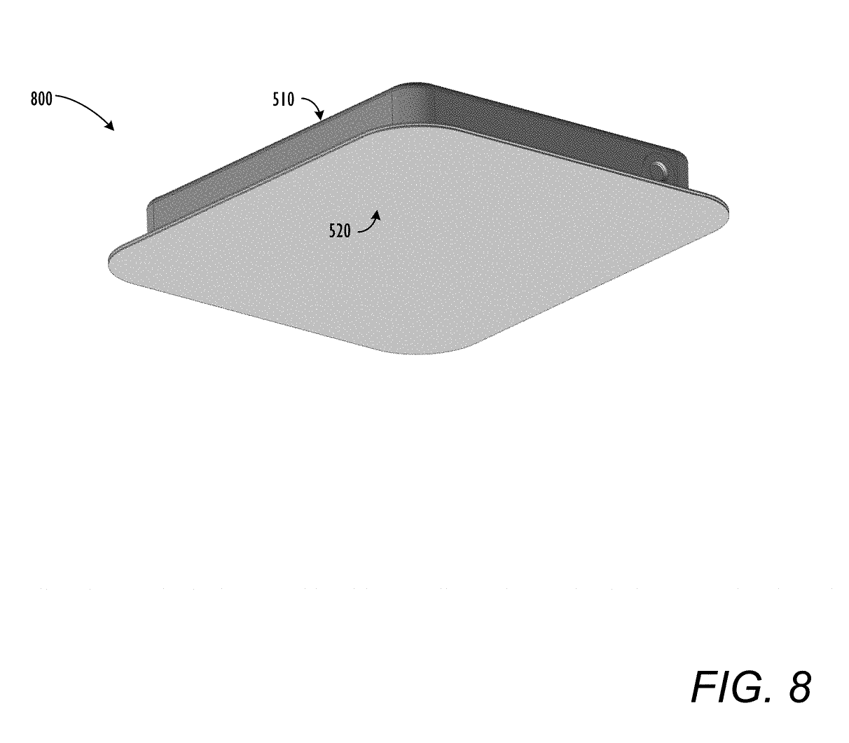

FIG. 8 illustrates a bottom view 800 of battery 500 with adhesive assembly. As shown herein, can 510 and cover 520 may produce the negative and positive terminals for battery 500, for example.

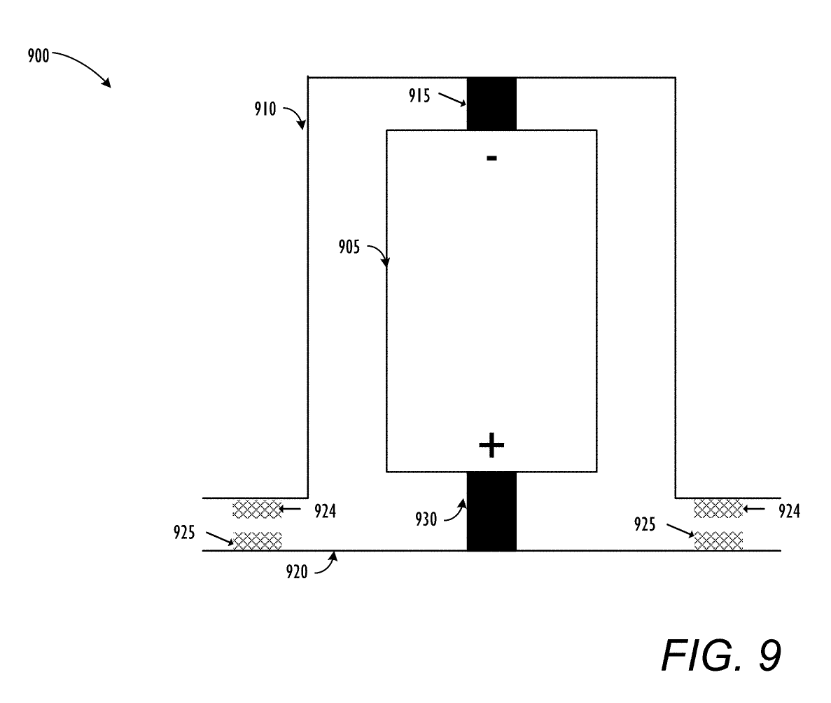

FIG. 9 illustrates an alternative battery 900 assembled using an insulating adhesive formed from an insulating bond. As shown in FIG. 9, battery 900 may include core 905 comprising a cathode and an anode. As noted above, the core may be constructed in a rolled or stacked configuration. A first electrode (e.g., cathode) of core 905 may be electrically connected to can 910 through electrical lead 915 using, for example, welding, pressure contact, conductive adhesive, etc. Battery 900 may also include cover 920, which may be mechanically coupled to can 910 using an insulating bond formed from polymer layers 924 and 925 as described below so as to form a casing enclosing core 905. Further, a second electrode (e.g., anode) of core 905 may be electrically connected to cover 920 through lead 930. Thus, the cathode of core 905 and can 910 may form a negative terminal for battery 900. Conversely, the anode of core 905 and cover 920 may produce a positive terminal for battery 900. It will be appreciated that the electrical connections to the anode and cathode may be reversed so that the cathode is connected to cover 920 and the anode is connected to can 910.

Battery 900 uses an insulating bond formed from polymer layers 924 and 925 to mechanically couple can 910 and cover 920. Like the embodiments described above with respect to FIGS. 5-8, battery 900 may eliminate the need for a feed-through between lead 930 and cover 920. The insulating bond can differ from those discussed above in that it may be formed from a polymer layer 924 disposed on can 910 and a polymer layer 925 disposed on cover 920. In some embodiments, this polymer layer may be a polypropylene layer disposed on the metallic can and cover using known techniques (including any required substrate to effectuate bonding of the polypropylene to the metallic can and cover). Such techniques may be similar to those used in sealing pouch-type cells around their leads. With a suitable polymer layer 924 formed on can 910 and a suitable polymer layer 925 formed on cover 920, the two may be brought into mechanical contact and heated so that the polymer layers melt together to form an insulating bond. It will be appreciated that the particular polymer material and/or any required substrate material used in a particular embodiment should be selected to be compatible with the associated battery chemistry. In other respects, battery 900 using an insulating bond is similar to the embodiments described above with respect to FIGS. 6-8.

The various embodiments described above are provided by way of illustration only and should not be constructed to limit the scope of the disclosure. Various modifications and changes can be made to the principles and embodiments herein without departing from the scope of the disclosure and without departing from the scope of the claims.

1. A battery, comprising
a core comprising a first electrode and a second electrode;
an electrically conducting can containing the core and electrically coupled to the first electrode; and
an electrically conducting cover closing the can and electrically coupled to the second electrode;
wherein the cover is affixed to the can using an electrically insulating adhesive.

2. The battery of claim 1, wherein the electrically insulating adhesive comprises an acrylic adhesive.

3. The battery of claim 1, wherein the electrically insulating adhesive is a tape having a polymer substrate with adhesive on both sides.

4. The battery of claim 3, wherein the tape comprises at least one of a styrene butadiene rubber, a polyvinylidene fluoride, or a polytetrafluoroethylene.

5. The battery of claim 3 wherein the electrically insulating adhesive is an insulating bond formed from a polymer disposed on the electrically conducting can and a polymer disposed on the electrically conducting cover.

6. The battery of claim 1, wherein the core is a stacked cell core having a plurality of electrodes electrically connected to form an anode and a second plurality of electrodes electrically connected to form a cathode.

7. A battery assembly method, comprising:
disposing a battery core having a first electrode and a second electrode within an electrically conducting can;
electrically coupling the first electrode to the can;
electrically coupling a second electrode of the battery to an electrically conducting cover; and
affixing the cover to the can so as to close the can using an electrically insulating adhesive.

8. The battery assembly method of claim 7, wherein the electrically insulating adhesive comprises an acrylic adhesive.

9. The battery assembly method of claim 7, wherein the electrically insulating adhesive is a tape having a polymer substrate with adhesive on both sides.

10. The battery assembly method of claim 9, wherein the tape comprises at least one of a styrene butadiene rubber, a polyvinylidene fluoride, or a polytetrafluoroethylene.

11. The battery assembly method of claim 7 wherein affixing the cover to the can so as to close the can using an electrically insulating adhesive further comprises:
disposing a polymer on the can;
disposing a polymer on the cover;
bringing the can and cover into contact; and
applying heat thereby causing the polymer disposed on the can and the polymer disposed on the cover to form an insulating bond.

12. The battery assembly of claim 7, wherein the battery core is a stacked cell core having a plurality of electrodes electrically connected to form an anode and a second plurality of electrodes electrically connected to form a cathode.

13. An battery assembly, comprising:
a core comprising a first electrode and a second electrode;
an electrically conducting can containing the core and electrically coupled to the first electrode;
an electrically conducting cover closing the can and electrically coupled to the second electrode; and
means for mechanically coupling the cover to the can so as to contain the core and provide electrical insulation between the cover and the can.

14. The battery assembly of claim 13, wherein the means for mechanically coupling the cover to the can so as to contain the core and provide electrical insulation between the cover and the can comprises an acrylic adhesive.

15. The battery assembly of claim 13, wherein the means for mechanically coupling the cover to the can so as to contain the core and provide electrical insulation between the cover and the can comprises a styrene butadiene rubber.

16. The battery assembly of claim 13, wherein the means for mechanically coupling the cover to the can so as to contain the core and provide electrical insulation between the cover and the can comprises a polyvinylidene fluoride.

17. The battery assembly of claim 13, wherein the means for mechanically coupling the cover to the can so as to contain the core and provide electrical insulation between the cover and the can comprises a polytetrafluoroethylene.

18. The battery assembly of claim 13, wherein the means for mechanically coupling the cover to the can so as to contain the core and provide electrical insulation between the cover and the can comprises a polypropylene.

19. The battery assembly of claim 13, wherein the first electrode is a cathode and the second electrode is an anode.

20. The battery assembly of claim 13, wherein the first electrode is an anode and the second electrode is a cathode.
